(19) United States
(12) Patent Application Publication
(10) Pub. No.: US 2004/0054463 A1
(43) Pub. Date: Mar. 18, 2004

(54) Position determination using a mobile appliance

(76) Inventor: Gerhard Bock, Gauting (DE)

Correspondence Address: BELL, BOYD & LLOYD, LLC, P. O. BOX 1135, CHICAGO, IL, 60690-1135, US

(21) Appl. No.: 10/470,560

(22) PCT Filed: Jan. 23, 2002
(86) PCT No.: PCT/EP02/00655

(30) Foreign Application Priority Data
Jan. 29, 2001 (EP) 01101977.5

(51) Int. Cl. G01C 21/30; H04N 7/00

(52) U.S. Cl. 701/207; 348/116

(57) ABSTRACT

The invention relates to a method for position determination using an image recording device which is suitable for communication. An image data record is transmitted to a central location where the image content is evaluated in terms of its position. The result is transmitted back to the image recording device and outputted.

The invention relates to a method for position determination using an image recording device which is capable of communication

Examples of an image recording device of this type include a video mobile radio device, what is called a video mobile phone, and a digital camera with a link to a mobile radio network.

For people who are touring the sites of unfamiliar cities their present location is often of interest for purposes of orientation. In some circumstances they may also wish to know the name of a building that is within their field of vision. Until now it has only been possible to obtain this information by asking passers-by.

The object of the invention is to describe a method of the type cited at the start.

This object is alternatively also achieved according to the invention by means of the features described in claim 1 or 2.

The invention is described below with reference to an exemplary embodiment.

The invention proceeds from a video mobile radio device or digital camera.

For position determination or obtaining information about buildings and the like during a visit to the sites in a city, for instance, but also in open country, the camera is pointed at salient details in the surrounding area and an image is made of them. According to the invention, the image made by the camera is compared with a city guide database, for example, and the required information acquired from the image content. The name of a building ultimately also results in position determination.

This database can either be loaded into the mobile radio device or a digital camera via radio, or it is inserted by means of a storage medium, for example in the form of a multimedia card.

In a variant of the invention the image is evaluated at a central location, for example in a server provided by the municipal authority which is connected to the mobile radio network.

1. Method for position determination using an image recording device which is suitable for communication. An image data record is transmitted to a central location where the image content is evaluated in terms of its position. The result is transmitted back to the image recording device and outputted.

2. Method for position determination using an image recording device which is suitable for communication. An image database is loaded into the image recording device during which position-determining data relating to the image content is stored, the content of an image that has been made is compared with the database, and the data is outputted.
